(19) United States
(12) Patent Application Publication
(10) Pub. No.: US 2023/0384433 A1
(43) Pub. Date: Nov. 30, 2023

(54) OPTICAL RANGE FINDING

(71) Applicant: NATIONAL UNIVERSITY OF SINGAPORE, Singapore (SG)

(72) Inventors: Peng Kian TAN, Singapore (SG); Christian KURTSIEFER, Singapore (SG)

(21) Appl. No.: 18/250,686

(22) PCT Filed: Oct. 28, 2021
(86) PCT No.: PCT/SG2021/050660

§ 371 Date: Apr. 26, 2023

(30) Foreign Application Priority Data
Oct. 28, 2020 (SG) 10202010688R

(51) Int. Cl. G01S 7/4865; G01S 7/481; G01S 17/10

(52) U.S. Cl. CPC G01S 7/4865; G01S 7/4816; G01S 7/4814; G01S 17/10

(57) ABSTRACT

An optical range finding device and an optical range finding method. The method comprises the steps of generating light with a super Poissonian timing statistic; splitting the light into a reference beam and a probe beam and directing the probe beam towards a target in free-space; illuminating a first single-photon detector by the reference beam; illuminating a second single-photon detector by the probe beam after reflection by the target in free-space; detecting a time difference between detection of quantum-correlated photons in the reference beam and the reflected probe beam for determining a distance between the device and the target.

### FIELD OF INVENTION

The present invention relates broadly to a method and device for optical range finding, in particular to optical range finding using quantum correlations in light with a super-Poissonian photon statistics.

### BACKGROUND

Any mention and/or discussion of prior art throughout the specification should not be considered, in any way, as an admission that this prior art is well known or forms part of common general knowledge in the field.

Quantum-based radar or light detection and ranging, lidar, has been proposed as a range finding mechanism. For example, U.S. Pat. No. 7,375,802B2 entitled “Radar systems and methods using entangled quantum particles” uses a complex and expensive entangled photon pair source, with associated multiple points-of-failure.

Embodiments of the present invention seek to address at least one of the above problems.

### SUMMARY

In accordance with a first aspect of the present invention, there is provided an optical range finding device comprising:
a light source configured to generate light with a super-Poissonian timing statistic;
an optical module for splitting the light into a reference beam and a probe beam and for directing the probe beam towards a target in free-space;
a first single-photon detector configured for illumination by the reference beam;
a second single-photon detector configured for illumination by the probe beam after reflection by the target in free-space;
a timing module coupled to the first and second single-photon detectors for detecting a time difference between detection of quantum-correlated photons in the reference beam and the reflected probe beam for determining a distance between the device and the target.

In accordance with a second aspect of the present invention, there is provided an optical range finding method comprising the steps of:
generating light with a super-Poissonian timing statistic;
splitting the light into a reference beam and a probe beam and directing the probe beam towards a target in free-space;
illuminating a first single-photon detector by the reference beam;
illuminating a second single-photon detector by the probe beam after reflection by the target in free-space;
detecting a time difference between detection of quantum-correlated photons in the reference beam and the reflected probe beam for determining a distance between the device and the target.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 shows a schematic illustration of a range finding method and device, according to an example embodiment.

FIG. 2 shows the two-photoevent coincidence histogram traces for photodetection time differences between the reflected probe beam and the reference beam, according to an example embodiment.

FIG. 3 shows a schematic illustration of a range finding method and device according to an example embodiment,

FIG. 4 shows a schematic illustration of a range finding method and device according to an example embodiment,

FIG. 5 shows a flowchart illustrating an optical range finding method according to an example embodiment.

### DETAILED DESCRIPTION

Embodiments of the present invention exploit the quantum correlations in super-Poissonian photon statistics light to perform distance measurement, which may for example be applied to quantum radar or lidar modules in autonomous vehicles.

Brown, R. Hanbury; Twiss, R. Q. (1956): Correlation between Photons in two Coherent Beams of Light, Nature. 177 (4497): 27-29. (1956) described the photon correlation techniques used in example embodiments. The phenomenon is now referred to as Hanbury-Brown and Twiss effect, HBT effect, or intensity interferometry, and has previously been applied to measure the apparent size of stars. More recently, the technique has been applied to characterize the photon statistics of light emitted by non-classical light sources like single photon sources.

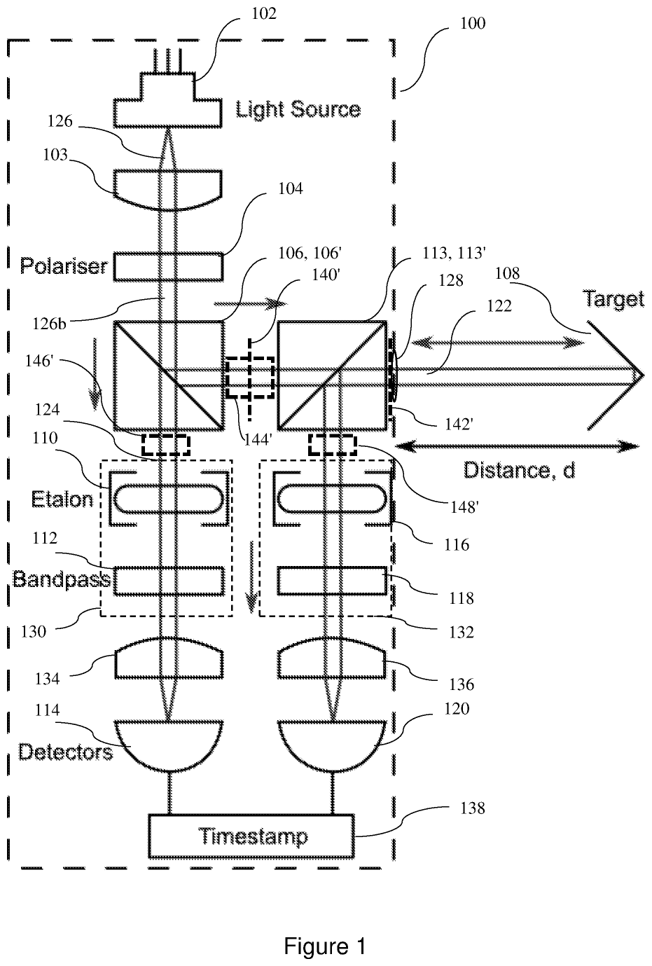

FIG. 1 shows a schematic illustration of a range finding method and device 100 based on quantum fluctuations of a light source with super-Poissonian photon statistics, according to an example embodiment. The light source 102 creates an optical field with a characteristic intensity correlation, referred to as temporal photon bunching signature. A polarizer, here in the form of a linear polarizer 104, helps to increase this characteristic intensity correlation as a timing signature for the measurement process. One part of that light field is separated with a non-polarizing beam-splitter 106 and sent to the target 108, the other part is directed through a combination of an etalon, here in the form of a Fabry-Perot solid etalon 110, and interference filter, here in the form of an interference filter 112, to select a narrow wavelength range onto a single photon detector 114. The light field returning from the target 108 is passed, via a non-polarizing beam-splitter 113, through a filter combination with the same elements 116, 118 compared to elements 110, 112 to a second single photon detector 120. Timing analysis of the two photodetection event streams allows to reconstruct the delay time between reflected probe beam 122 and reference beam 124, leading to a distance measurement.

In more detail, the light source 102 used in an example embodiment is a semiconductor diode laser operating below lasing threshold, and so emits light 126 with super-Poissonian photon statistics rather than Poissonian photon statistics when operating above the lasing threshold.

As will be appreciated by a person skilled in the art, super-Poissonian photon statistics has a wider spectral envelope than Poissonian photon statistics, exhibiting a statistical distribution with variance Δn²><n>, as opposed to variance Δn²=<n> for Poissonian photon statistics. The super-Poissonian photon statistics is used to imprint a temporal signature on the light 126 field, which then is used to measure the round-trip (2*distance, d) time from the device 100 to the target 108 and back, as will be described below.

This light 126 is collimated using a collimator 103 and sent through the linear polarizer 104 to increase the temporal photon bunching signature in the polarized light 126b seen by detectors 114, 120. It is noted that photons with super-Poissonian statistics that are of the same spatial mode, polarization mode and spectral distribution, are correlated within their coherence timescale; thus any differences between their polarization mode overlap will reduce the correlation between the reference and probe beams, and hence the measurable temporal photon bunching signature. Accordingly, enforcing the same polarization using a polarizer, in a non-limiting example the linear polarizer 104, increases the temporal photon bunching signature.

The polarized light 126b is sent through the non-polarizing beam-splitter 106 into the probe beam 122 which is sent in free-space to the target 108 of interest, and the reference beam 124 which is retained within the device 100 package.

The probe beam 122 is sent towards the target 108, whereby the reflected probe beam 122 can be collected via the same free-space optical path and aperture 128 as on the outward trajectory.

The distance, d, to the target 108 is related to the time-of-flight of the reflected probe beam 122 multiplied by the speed of light and divided by two.

The reflected probe beam 122 and reference beam 124 are sent through identical but separate spectral filtering modules 130, 132.

Each spectral filtering module 130, 132 first comprises the Fabry-Perot solid etalons 110, 116. The etalons 110, 116 are temperature-tuned to determine their peak transmission wavelengths. A Fabry-Perot etalon is an arrangement of two partially reflective surfaces that form a resonant structure for light fields that is transparent for a regular set of wavelengths, as is understood by a person skilled in the art.

The second stage of each spectral filtering module 130, 132 is an interference filter 112, 118 with a passband of a few nanometers. This helps to further select the specific wavelength range transmitted through the etalons 110, 116 and to be used for range finding.

The reflected probe beam 122 and reference beam 124 are then focused using lenses 134, 136 and collected by the pair of single photon detectors 114, 120, which may be in the form of a pair of actively quenched avalanche photon detectors. These photodetectors 114, 120 allow to measure the arrival time of a photon in the light field with a high timing resolution, typically with an accuracy of 10-1000 ps.

An electrical device like an oscilloscope or a dedicated time tagger is used in a time stamp module 138 to timestamp photodetection events from the two photodetectors 114, 120. An algorithm in the time stamp module 138 allows to efficiently identify pairs of quantum-correlated photodetection events between the reflected probe beam 122 and the reference beam 124, using the super-Poissonian photon statistics/temporal signature imprinted on the light 126/126b.

In an example embodiment, the algorithm considers all pairs of photodetection events between the two photo detectors 114, 120 as long as the detection time difference falls within a certain time interval [tₘᵢₙ, tₘₐₓ]. For example, consider that a first photon P1₁₁₄ is detected in detector 114 at t₁ and a second photon P2₁₁₄ is detected in detector 114 at t₂>t₁. On the other hand, a first photon P1₁₂₀ is detected in detector 120 at t₃ and a second photon P2₁₂₀ is detected in detector 120 at t₄>t₃. The algorithm considers all four pair events (P1₁₁₄, P1₁₂₀), (P2₁₁₄, P1₁₂₀), (P1₁₁₄, P2₁₂₀), and (P2₁₁₄, P2₁₂₀), with their respective time differences t₃−t₁, t₃−t₂, t₄−t₁, and t₄−t₂ as long as the difference falls into the interval [tₘᵢₙ, tₘₐₓ]. Quantum-correlated photon pairs are more likely to happen than uncorrelated photon pairs, which will show up as a peak in a histogram of all pair events and used to assess the time difference at which the quantum correlations appear. The upper bound tₘₐₓ can be chosen such that it includes a maximal round-trip time of a photon between beam splitter 113 to the target 108 and back to the beam splitter 113, whereas the lower bound tₘᵢₙ can be chosen to be 0, or slightly negative, or corresponding to a minimal round trip time between beam splitter 113 and the target 108 and back to 113 in order to suppress detection of nearby reflections.

The identified pairs of correlated photodetection events with their particular respective timing differences are then collected by the time stamp module 138 into a histogram of time differences. In a preferred embodiment, the histogram can be obtained efficiently by storing subsequent photodetection event times from detector 114 in a ring buffer, advancing a head pointer with each event. For each detection event of detector 120, the time difference to each stored event of detector 114 in the ring buffer between the head pointer and a tail pointer is evaluated, starting from the most recent one indicated by the head pointer, and the time difference is added to the histogram if the time difference does not exceed the chosen maximal round trip time, tₘₐₓ. If the difference exceeds the chosen maximal round trip time, all earlier events from detector 114 in the ring buffer are ignored from further consideration by advancing the tail pointer for the ring buffer to the last event with a time difference, compared to the most recent detection event of detector 120, that is smaller than the maximal round trip time. In one embodiment, tₘᵢₙ=0 is chosen. This process advantageously avoids storing a large number of event timing data, and can be processed from the stream of timestamp events. In different embodiments, the buffering process can be adapted for tₘᵢₙ>0 or tₘᵢₙ<0.

The timing position of the peak signal in this histogram, i.e. the two-photoevent coincidence distribution, corresponds to the time-of-flight of the probe beam to and from the target 108, from which the distance, d, can then be determined. In other words, this histogram will show a peak associated with the same (to within the measurement uncertainty) time difference between the correlated photon pairs (within the filtered band) as a result of the specific delay caused by the additional (2*distance, d) travelled by the photons in the reflected probe beam 122. This step corresponds roughly to the peak finding process when using a traditional lidar scheme when modulating the light source with a pseudorandom pattern. In one embodiment, the peak finding process can be integrated with the accumulation step of the histogram by comparing each histogram entry, i.e. the accumulated count of pairs with the same time difference, with the largest histogram value obtained so far at the time of incrementing a histogram entry. If the latest histogram value exceeds the largest value, the time difference for this event is stored, and considered the peak position for the histogram so far. The histogram amplitudes allow also for an assessment of the confidence into the peak identification, as the peak is expected to have up to twice the amplitude of the uncorrelated pair events away from the peak.

Demonstration measurements according to an example embodiment:

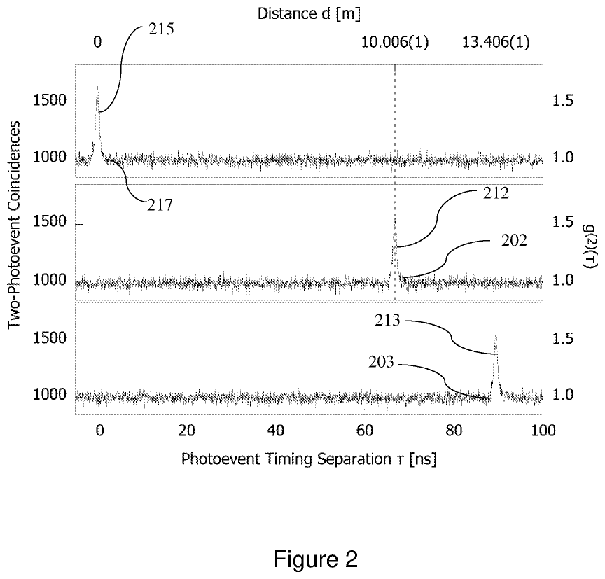

FIG. 2 shows the two-photoevent coincidence histogram traces 202, 203 for photodetection time differences between the reflected probe beam and the reference beam for two different specific delays caused by different respective additional distances (in meters) to a target travelled by the photons in the reflected probe beam. The peaks 212, 213 in the traces 202, 203 are indicative of the respective time-of-flight differences between reflected light in the reflected probe beam and the reference beam, for different distances, d, of several meters, while the peak 215 of trace 217 shows the reference beam photon event to find the “zero” time difference for calibration. The uncertainty for these distance measurements was around 1 mm, corresponding to a time resolution of 6 ps. In FIG. 2, the two vertical axes show the raw coincidences on the left, and the normalized coincidences on the right, which is proportional to the absolute value of the number of coincidence events and is indicated by the right y-axis label (g⁽²⁾(T)), i.e. the second order timing correlation. The normalization preferably allows identification of true peaks, as opposed to peaks caused e.g. by noise, easily, i.e., whenever the (g⁽²⁾(T)) is statistically significantly larger than 1.

Embodiments of the present invention rely on single photon detectors (114, 120, see FIG. 1), such as avalanche photodiodes, that permit to register the detection time of a single photon. Such detectors typically have a limited number of events per unit of time that they can process (typically on the order of 10 7 events/second). In one embodiment, a few 1000 detection events are being registered, resulting in the range finding process taking a few milliseconds in an example embodiment.

Returning to FIG. 1, in a modified embodiment the detector 114, 120 exposures are balanced to increase the signal-to-noise ratio. The linear polarizer 104 is rotated about the propagation axis of collimated beam 126/126b. The non-polarizing beam-splitter 106 is replaced with a polarizing beam-splitter in the same location indicated as 106′ in FIG. 1. This modification allows control over the ratio of intensities that transmits or reflects through the polarizing beam-splitter 106′, and hence control over the intensities of the reference beam 124 and probe beam 122. Thus by rotating the linear polarizer 104, the beam intensities exposed to the detectors 114 and 120 can be balanced, which is the optimal intensity ratio to maximize the signal-to-noise ratio and so reduce the integration time for measurement by time stamp module 138.

In another modified embodiment, replacing the non-polarizing beam-splitter 113 with a polarizing beam-splitter in the same location, indicated as 113′ in FIG. 1, can additionally or alternatively reduce the losses in the non-polarizing beam-splitter 113. A first half-wave plate 140′ is placed upstream of the polarizing beam-splitter 113′, between non-polarizing beam-splitter 106 (or the polarizing beam splitter 106′) and the polarizing beam-splitter 113′. The half-wave plate 140′ is rotated about the axis of propagation of probe beam 122, thus rotating the linear polarization mode of probe beam 122 such that it transmits through the polarizing beam-splitter 113′ with reduced or negligible reflection loss. A second quarter-wave plate 142′ in the same orientation (i.e. rotated by the same amount about the axis of propagation of probe beam 122) as the first half-wave plate is placed after, i.e. downstream of, the polarizing beam-splitter, before the aperture 128. This will cause the probe beam 122 to pass through the second quarter-wave plate twice, on its outwards and then its return path, thus rotating the linear polarization mode of probe beam 122 by 90 degrees, and so only reflecting (i.e. not splitting) at the polarizing beam-splitter on its return path to spectral filtering module 132, with reduced or negligible transmission loss.

In another modified embodiment, the effective range of the probe beam 122 can be improved by focusing, between beam-splitters 106 (106′) and 113 (113′), the probe beam 122 into a single-mode optical fiber or a pinhole to enforce spatial coherence, then collimating with a lens or reflective collimator, together indicated as 144′ and then transmitting through beam-splitter 113 (113′) to target 108, via aperture 128. This can improve the effective range in free-space (i.e. beyond aperture 128) whereby the probe beam 122 can illuminate target 108 and still be coupled back into the device 100.

In another modified embodiment, spatial coherence of reference beam 124 and probe beam 122 can optimize the performance of the spectral filtering modules 130 and 132. The incident reference and probe beams 124 and 122 can be made spatially coherent and collimated after the beam-splitters 106 (160′) and 113 (113′), before spectral filtering modules 130 and 132. In one embodiment, the beams 124, 122 are focused into respective single-mode optical fibers or pinholes to enforce spatial coherence, and then collimated with a lens or reflective collimator, together indicated as 146′, 148′ before illuminating the spectral filtering modules 130 and 132.

In another modified embodiment, depending on the spectral widths of the beam 126 from light source 102, the spectral filtering modules 130 and 132 may be implemented with other spectral filtering elements other than etalons (110,116) and interference filters (112,118), such as diffraction gratings, optical cavities (e.g. Fabry-Perot cavities) comprising of two separate mirrors with an adjustable spacer such as a piezoelectric or magnetostrictive transducer, prisms and combinations thereof.

In another modified embodiment, the filter modules 130, 132 may also use the actual same filtering element(s) for the reference and probe beam, i.e. the beams 122, 124 pass through the actual same filter element(s) in a single filter module, with the advantage of ideally “matched” resonances for both beams, For this purpose, any optical modes with the same transmission frequency may be used, identified for example by their polarization or spatial separation, or any other degree of freedom that allows sufficient beam combination and separation before and after the filtering element(s), respectively.

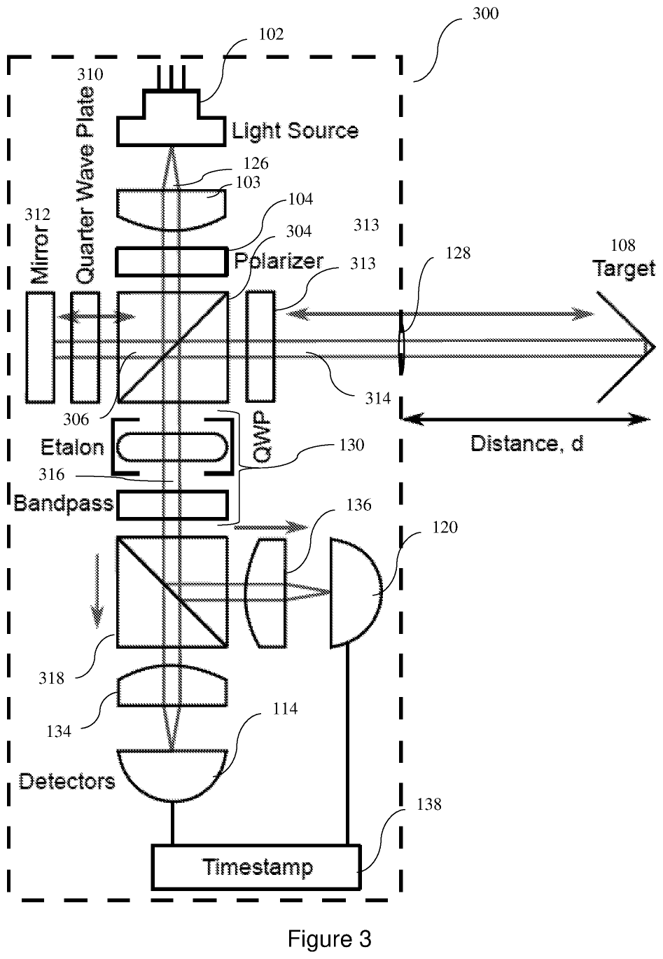

FIG. 3 shows a schematic illustration of a range finding method and device 300 according to another example embodiment, in which the reference and probe beams are separated using orthogonal polarization modes, and so passing through the same single spectral filtering module 130. Compared to the embodiment shown in FIG. 1, the beam-splitter 113 and spectral filtering module 132 are removed. Beam-splitter 106 is replaced with a polarizing beam-splitter 304. The linear polarizer 104 is rotated about the propagation axis of beam 126, to balance the detector exposures 114 and 120. The polarizing beam-splitter at 304 is rotated by 90 degree compared to the beam-splitter 106 (FIG. 1), such that the reflected beam 306 is counter propagating compared to probe beam 122 (FIG. 1). A quarter-wave plate 310 is placed in this reflected beam 306, and a mirror 312 at normal incidence to the beam 306, such that the linear polarization mode of the beam 306 is rotated by 90 degrees and will completely transmit through the polarizing beam-splitter 304 into the optical path of probe beam 314. Another quarter-wave plate 313 is placed between the polarizing beam-splitter 304 and aperture 128, such that the probe beam 314 after reflecting from target 108 in free space, will rotate its linear polarization mode by 90 degrees, and so completely reflect at polarizing beam-splitter 304. This will cause both the reference beam 316 and probe beam 314 to be co-propagating but of orthogonal linear polarization modes. Both beams 316, 314 will go through the same spectral filtering module 130. A polarizing beam-splitter 318 after the filtering module 130 will separate the reference beam 316 and probe beam 314, before focusing via lenses 134 and 136 into detectors 114 and 120.

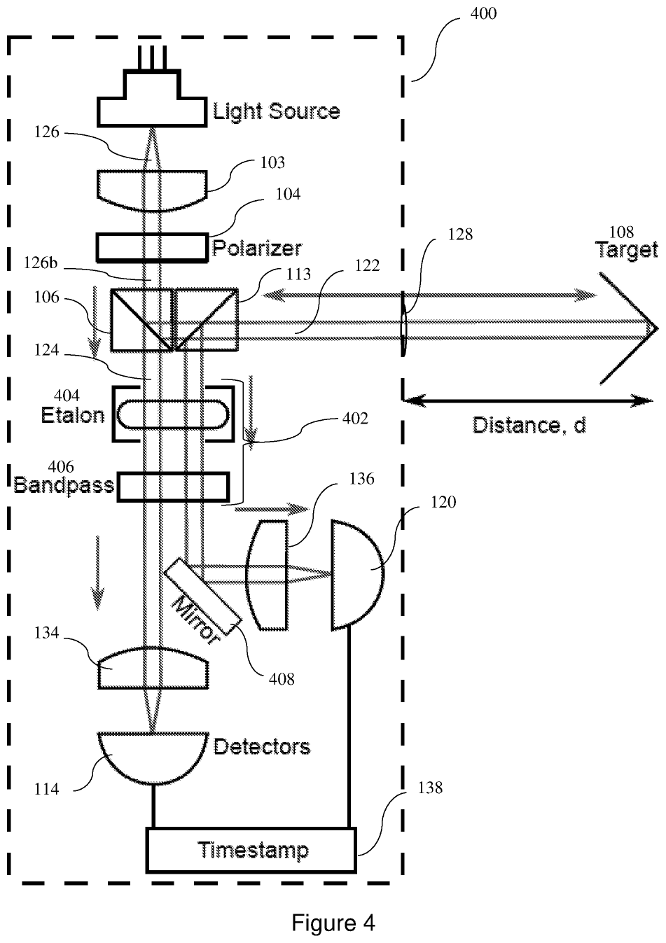

FIG. 4 shows a schematic illustration of a range finding method and device 400 according to another example embodiment, in which the reference and probe beams are separated using spatially separate optical paths but passing through the same single spectral filtering module 402. The light source emits beam 126 that is collimated by the lens 103. The collimated beam passes through the polarizer 104. The polarized beam 126b then transmits through the non-polarizing beam-splitter 106 to generate the reference beam 124, while reflecting through the same non-polarizing beam-splitter 106 to generate the probe beam 122. The probe beam 122 transmits through the second non-polarizing beam-splitter 113, through the aperture 128, to illuminate the target 108 in free space. Upon reflection from the target 108, the probe beam 122 reflects at the second non-polarizing beam-splitter 113. Now both the reference beam 124 and the probe beam 122 transmit through the same single spectral filtering module 402, which may comprise of an etalon 404 and an interference bandpass filter 406. The filtered probe beam 122 is then reflected by a mirror 408 to allow for larger spatial separation of the reference beam 124 and the probe beam 122, to make it easier for focusing via lenses 134, 136 into their respective detector modules 114, 120.

In one embodiment, there is provided an optical range finding device comprising a light source configured to generate light with a super-Poissonian timing statistic; an optical module for splitting the light into a reference beam and a probe beam and for directing the probe beam towards a target in free-space; a first single-photon detector configured for illumination by the reference beam; a second single-photon detector configured for illumination by the probe beam after reflection by the target in free-space; a timing module coupled to the first and second single-photon detectors for detecting a time difference between detection of quantum-correlated photons in the reference beam and the reflected probe beam for determining a distance between the device and the target.

The device may comprise a polarizer for polarizing the light generated by the light source prior to the splitting of the light, for increasing a temporal photon bunching signature of the light emitted from the light source.

The device may comprise one or more optical elements for bandpass filtering of the reference beam and the reflected probe beam prior to detection by the first and second detectors.

The one or more optical elements for filtering may comprise sets of one or more identical components for the reference beam and the reflected probe beam, respectively.

The one or more optical elements for filtering may comprise one set of one or more components for the reference beam and the reflected probe beam.

The device may comprise one or more coherence elements for enforcing spatial coherence of the target beam for increasing a range of the target beam in free space and/or for optimizing optical coherence between the reference beam and the probe beam.

The light source may comprise one of a group consisting of a laser source configured to generate the light below lasing threshold, super-luminescent diode, sub-threshold gas or solid state laser, semiconductor laser, light emitting diode, arc lamp, incandescent light bulb, Sunlight and starlight, blackbody radiator, and a mode-hopping laser.

Each of the first and second detectors may be able to detect the arrival time of a single photon with a timing accuracy commensurate or higher than the coherence time of the photons. Each of the first and second detectors may comprise one of a group consisting of a photomultiplier, superconducting nanowire or transition edge detector, and actively or passively quenched avalanche diode photon detector.

The optical module for splitting the light into the reference beam and the probe beam may polarizing.

The device may comprise a rotatable polarizer for balancing beam intensities exposed to the first and second single-photon detectors.

The device may comprise two waveplates disposed for minimizing losses in the optical module for splitting the light into the reference beam and the probe beam.

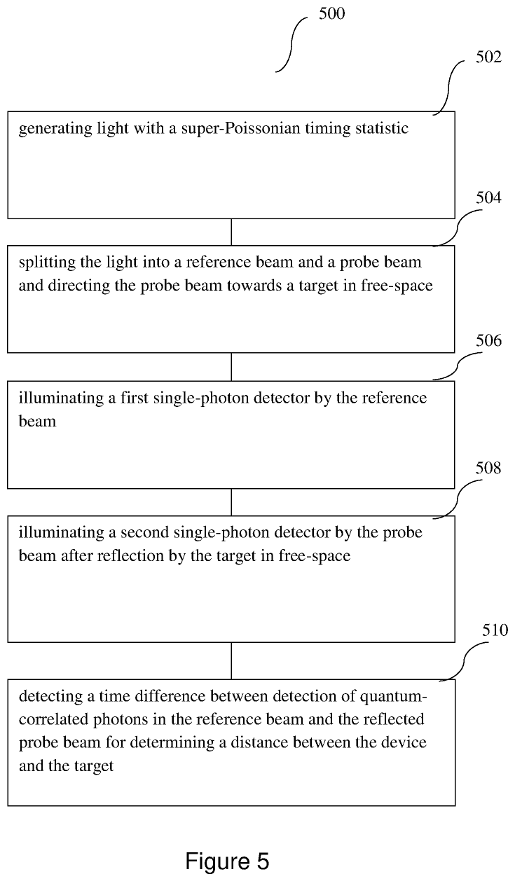

FIG. 5 shows a flowchart 500 illustrating an optical range finding method according to an example embodiment. At step 502, light with a super-Poissonian timing statistic, is generated. At step 504, the light is split into a reference beam and a probe beam and the probe beam is directed towards a target in free-space. At step 506, a first single-photon detector is illuminated by the reference beam. At step 508, a second single-photon detector is illuminated by the probe beam after reflection by the target in free-space. At step 510, a time difference between detection of quantum-correlated photons in the reference beam and the reflected probe beam is detected for determining a distance between the device and the target.

The method may comprise polarizing the generated light prior to the splitting of the light, for increasing a temporal photon bunching signature of the light.

The method may comprise bandpass filtering of the reference beam and the reflected probe beam prior to detection by the first and second detectors.

The method may comprise enforcing spatial coherence of the target beam for increasing a range of the target beam in free space.

The method may comprise optimizing optical coherence between the reference beam and the probe beam.

The method may comprise balancing beam intensities exposed to the first and second single-photon detectors.

The method may comprise minimizing losses in the optical module for splitting the light into the reference beam and the probe beam.

Embodiments of the present invention can have one or more of the following features and associated benefits/advantages:

| Feature | Benefit/Advantage |
|---|---|
| Stationary light source via a sub-threshold | Stealth: |
| laser diode. | Absence of timing modulation according to |
| | example embodiments makes it difficult for a |
| | third-party to discover. |
| Super-Poissonian photon statistics with a | Stealth: |
| relatively wide spectral envelope in the | Absence of a single-emission-line when |
| probe beam, e.g. a few nanometres or more. | embedded in spectrally broadband ambient |
| | light according to example embodiments |
| | makes it difficult for a third-party to discover, |
| | i.e. the spectrum looks comparable to ambient |
| | or environmental light sources such as |
| | street/urban lighting via LEDs, for example. |
| Narrowband spectral filtering using Fabry- | Signal-to-noise ratio: Suppresses broadband |
| Perot etalons. | ambient light such as Sunlight in daytime and |
| | LED street lighting at night. |
| Exploiting super-Poissonian photon | Crosstalk rejection: |
| statistics photon bunching to provide the | Accidental crosstalk, by lidar from multiple |
| quantum correlations whereby time-of- | autonomous vehicles; |
| flight information is extracted to determine | Intentional crosstalk, anti-decoy/jamming |
| distance. | signals by a third-party. |
| | That is, the quantum correlations exploited |
| | according to example embodiments cannot be |
| | reproduced by a third-party and injected into |
| | this system, whether by accident or intent, |
| | even if the third-party system is identical in |
| | design. |

Aspects of the systems and methods described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the system include: microcontrollers with memory (such as electronically erasable programmable read only memory (EEPROM), embedded microprocessors, firmware, software, etc. Furthermore, aspects of the system may be embodied in microprocessors having software-based circuit emulation, discrete logic (sequential and combinatorial), custom devices, fuzzy (neural) logic, quantum devices, and hybrids of any of the above device types.

Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

The various functions or processes disclosed herein may be described as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. When received into any of a variety of circuitry (e.g. a computer), such data and/or instruction may be processed by a processing entity (e.g., one or more processors).

The above description of illustrated embodiments of the systems and methods is not intended to be exhaustive or to limit the systems and methods to the precise forms disclosed. While specific embodiments of, and examples for, the systems components and methods are described herein for illustrative purposes, various equivalent modifications are possible within the scope of the systems, components and methods, as those skilled in the relevant art will recognize. The teachings of the systems and methods provided herein can be applied to other processing systems and methods, not only for the systems and methods described above.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive. Also, the invention includes any combination of features described for different embodiments, including in the summary section, even if the feature or combination of features is not explicitly specified in the claims or the detailed description of the present embodiments.

For example, light sources with super-Poissonian photon statistics for use in example embodiments include super-luminescent diodes, sub-threshold gas or solid state lasers (including semiconductor lasers), light emitting diodes, arc lamps, incandescent light bulbs, Sunlight and starlight, blackbody radiators, and mode-hopping lasers. Preferably, the light source has a sufficiently high spectral brightness so that the photon bunching effect can be measured in hours or faster, for practical considerations, for example 10\hat{ }4 photons per second per GHz or more.

As another example, the light detectors can be any detector that is able to detect the arrival time of a single photon with a timing accuracy commensurate or higher than the coherence time of the photons. Examples for such photodetectors are photomultipliers, superconducting nanowire detectors, superconducting transition edge detectors, and actively or passively quenched avalanche diode photon detector.

In general, in the following claims, the terms used should not be construed to limit the systems and methods to the specific embodiments disclosed in the specification and the claims, but should be construed to include all processing systems that operate under the claims. Accordingly, the systems and methods are not limited by the disclosure, but instead the scope of the systems and methods is to be determined entirely by the claims.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

We claim:

1. In accordance with a first aspect of the present invention, there is provided an optical range finding device comprising:
a light source configured to generate light with a super-Poissonian timing statistic;
an optical module for splitting the light into a reference beam and a probe beam and for directing the probe beam towards a target in free-space;
a first single-photon detector configured for illumination by the reference beam;
a second single-photon detector configured for illumination by the probe beam after reflection by the target in free-space;
a timing module coupled to the first and second single-photon detectors for detecting a time difference between detection of quantum-correlated photons in the reference beam and the reflected probe beam for determining a distance between the device and the target.

2. The device of claim 1, comprising a polarizer for polarizing the light generated by the light source prior to the splitting of the light, for increasing a temporal photon bunching signature of the light emitted from the light source.

3. The device of claim 1, comprising one or more optical elements for bandpass filtering of the reference beam and the reflected probe beam prior to detection by the first and second detectors.

4. The device of claim 3, wherein the one or more optical elements for filtering comprise sets of one or more identical components for the reference beam and the reflected probe beam, respectively.

5. The device of claim 3, wherein the one or more optical elements for filtering comprise one set of one or more components for the reference beam and the reflected probe beam.

6. The device of claim 1, comprising one or more coherence elements for enforcing spatial coherence of the target beam for increasing a range of the target beam in free space and/or for optimizing optical coherence between the reference beam and the probe beam.

7. The device of claim 1, wherein the light source comprises one of a group consisting of a laser source configured to generate the light below lasing threshold, super-luminescent diode, sub-threshold gas or solid state laser (including semiconductor laser), light emitting diode, arc lamp, incandescent light bulb, Sunlight and starlight, blackbody radiator, and a mode-hopping laser.

8. The device of claim 1, wherein each of the first and second detectors is able to detect the arrival time of a single photon with a timing accuracy commensurate or higher than the coherence time of the photons.

9. The device of claim 8, wherein each of the first and second detectors comprise one of a group consisting of a photomultiplier, superconducting nanowire detector, superconducting transition edge detector, and actively or passively quenched avalanche diode photon detector.

10. The device of claim 1, wherein the optical module for splitting the light into the reference beam and the probe beam is polarizing.

11. The device of claim 10, comprising a rotatable polarizer for balancing beam intensities exposed to the first and second single-photon detectors.

12. The device of claim 10, comprising two waveplates disposed for minimizing losses in the optical module for splitting the light into the reference beam and the probe beam.

13. An optical range finding method comprising the steps of:
generating light with a super-Poissonian timing statistic;
splitting the light into a reference beam and a probe beam and directing the probe beam towards a target in free-space;
illuminating a first single-photon detector by the reference beam;
illuminating a second single-photon detector by the probe beam after reflection by the target in free-space;
detecting a time difference between detection of quantum-correlated photons in the reference beam and the reflected probe beam for determining a distance between the device and the target.

14. The method of claim 13, comprising polarizing the generated light prior to the splitting of the light, for increasing a temporal photon bunching signature of the light.

15. The method of claim 13, comprising bandpass filtering of the reference beam and the reflected probe beam prior to detection by the first and second detectors.

16. The method of claim 13, comprising enforcing spatial coherence of the target beam for increasing a range of the target beam in free space.

17. The method of claim 13, comprising optimizing optical coherence between the reference beam and the probe beam.

18. The method of claim 13, comprising balancing beam intensities exposed to the first and second single-photon detectors.

19. The method of any one of claim 13, comprising minimizing losses in the optical module for splitting the light into the reference beam and the probe beam.
